(19) United States
(12) Patent Application Publication
(10) Pub. No.: US 2010/0165640 A1
(43) Pub. Date: Jul. 1, 2010

(54) OPTICAL MEMBER OF LIGHTING DEVICE

(76) Inventors: Lung-Sheng LIN, Chupei City (TW); Chun-Wei SUN, Chupei City (TW); Ching-Tsung NI, Chupei City (TW)

Correspondence Address: Muncy, Geissler, Olds & Lowe, PLLC, 4000 Legato Road, Suite 310, FAIRFAX, VA, 22033, US

(21) Appl. No.: 12/465,154

(22) Filed: May 13, 2009

(30) Foreign Application Priority Data
Dec. 25, 2008 (TW) 097150776

(51) Int. Cl. F21V 5/00

(52) U.S. Cl. 362/336

(57) ABSTRACT

An optical member of lighting device is revealed. The optical member consists at least one emergent surface that is a spherical surface or an aspherical surface, and at least one incident surface with a V-shaped groove or a V-shaped like groove. The V-shaped groove is formed by two symmetrical or asymmetrical slants while the V-shaped like groove is formed by a plurality of curves. Moreover, axes of the emergent surface and the incident surface can be overlapped, shift relatively, slanted relatively to each other or combinations of them. When the optical member is used in combination with at least one solid state lighting element, an asymmetrical batwing light distribution pattern that features on non-zero maximum light intensity is generated. Thus the area being emitted is with uniform luminance and the availability of light is improved.

### BACKGROUND OF THE INVENTION

The present invention relates to an optical member of lighting device, especially to an optical member whose incident surface is disposed with a V-shaped groove, or a V-shaped like groove formed by a plurality of curves so as to generate an asymmetrical batwing light distribution pattern.

A solid state lighting element is broadly applied to light sources of lighting devices such as flashlights, table lamps, car lights, street lights or other auxiliary lighting of electronics. Take street lights as an example, most of the solid state lights available now includes symmetrical collimation optical element or no optical element and this leads to uneven distribution of illuminance, alternating light and dark bands. Moreover, while using the solid state lighting element as a light source, the package structure of each solid state lighting element has been disposed with a first optical element basically while a second optical element is arranged before the first optical element so as to improve efficiency of the solid state lighting element. That means the second optical element is used to increase the effective luminance, reduce process losses or adjust the light emitting direction, area and evenness of illuminance.

There is a plurality of prior arts related to designs of the first optical element and/or the second optical element mentioned above. For example, the US Pub. No. 2005/0243570 reveals an optical element whose incident surface and emergent surface are formed by symmetrical and special shapes. In U.S. Pat. No. 6,940,660, an incident surface of an optical element is formed by a plurality of confocally disposed annular reflectors surrounding a central region so as to direct the incident light to an emergent direction nearly parallel forward. Refer to U.S. Pat. No. 6,940,660, an incident surface of an optical element includes a sawtooth optical portion that guides most of incident light into a lateral side thereof. Thus there is a need to provide a lighting device that includes solid state lighting elements as light sources with the features of simple structure, higher lighting availability and effectiveness, even lighting distribution, easy assembling and low cost.

### SUMMARY OF THE INVENTION

Therefore it is a primary object of the present invention to provide an optical member of lighting devices used together with solid state lighting element to form a lighting device. A light emergent surface of the optical member is a spherical surface or an aspherical surface. An incident surface of the optical member is a V-shaped groove formed by two symmetrical or asymmetrical slants. Or the incident surface is a V-shaped like groove formed by a plurality of lines or curves. Or it is a V-shaped like groove formed by a paraboloid, an ellipsoid or an aspherical surface. Or it may be formed by a curved lead angle disposed on top of the V-shaped groove.

Thereby, when the optical member is used in combination with at least one solid state lighting element, light from the solid state lighting element passes the surface of the V-shaped groove or V-shaped like groove on the incident surface. The incident light of the two slants of the V-shaped (like) groove is refracted at a certain angle in opposite directions, entering into the optical member then and projected outward through the emergent surface. An asymmetrical batwing light distribution pattern is generated so that the illuminance and luminance on the area to be emitted are uniformed.

The optical axis of the incident surface as well as the emergent surface of the optical member can be overlapped, shifted relatively, slanted relatively to each other or combinations of them. Users can select proper optical members according to their requirements. Thus the options of the optical members are increased and the efficiency of the lighting device is further improved.

The optical member includes a plurality of emergent surfaces and corresponding incident surfaces. For example, the four emergent surfaces and corresponding incident surfaces are arranged in an array or in an alternating way to form a multilens unit in an integrated way. Thus the manufacturing as well as assembling is simplified and the manufacturing cost is reduced.

The emergent surface of the optical member is a spherical surface or an aspherical surface which is designed according to the spherical optical equation or the aspherical optical equation as to generate required light distribution patterns. For example, a concave is disposed on a surface of the emergent surface so that an asymmetrical batwing light pattern is generated.

### BRIEF DESCRIPTION OF THE DRAWINGS

FIG. 1 to FIG. 3 show an incident surface, an emergent surface and a cross sectional view used in combination with a solid state lighting element of an embodiment according to the present invention;

FIG. 4 to FIG. 6 show an incident surface, an emergent surface and a cross sectional view used in combination with a solid state lighting element of another embodiment according to the present invention;

FIG. 7 to FIG. 9 show an incident surface, an emergent surface and a cross sectional view used in combination with a solid state lighting element of a further embodiment according to the present invention;

FIG. 10 to FIG. 12 show an incident surface, an emergent surface and a cross sectional view used in combination with a solid state lighting element of a further embodiment according to the present invention;

FIG. 13 to FIG. 15 show an incident surface, an emergent surface and a cross sectional view used in combination with a solid state lighting element of a further embodiment according to the present invention;

FIG. 16 to FIG. 18 show an incident surface, an emergent surface and a cross sectional view used in combination with a solid state lighting element of a further embodiment according to the present invention;

FIG. 19 is a cross sectional view of the embodiment in FIG. 18 turn 90 degrees;

FIG. 20 to FIG. 22 show an incident surface, an emergent surface and a cross sectional view used in combination with a solid state lighting element of a further embodiment according to the present invention;

FIG. 23 to FIG. 24 show state in use and a top view of a further embodiment having an optical member with two solid state lighting elements according to the present invention;

FIG. 25 to FIG. 26 show state in use and a top view of a further embodiment having an optical member with two solid state lighting elements according to the present invention;

FIG. 27 is a polar graph of light patterns generated by an embodiment in FIG. 16 and the light patterns having a batwing light pattern B and a light pattern C.

### DETAILED DESCRIPTION OF THE PREFERRED EMBODIMENT

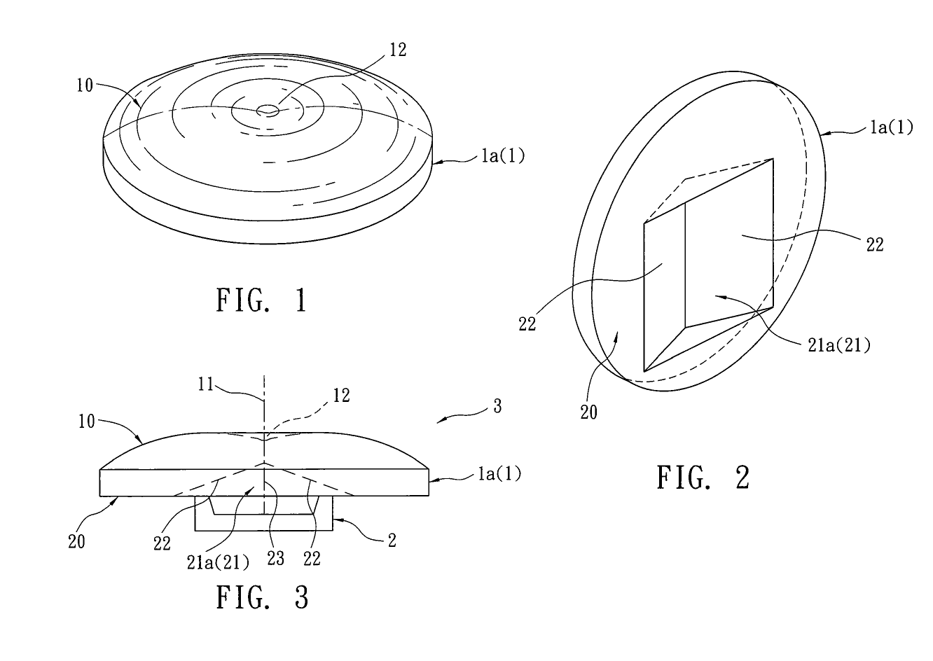

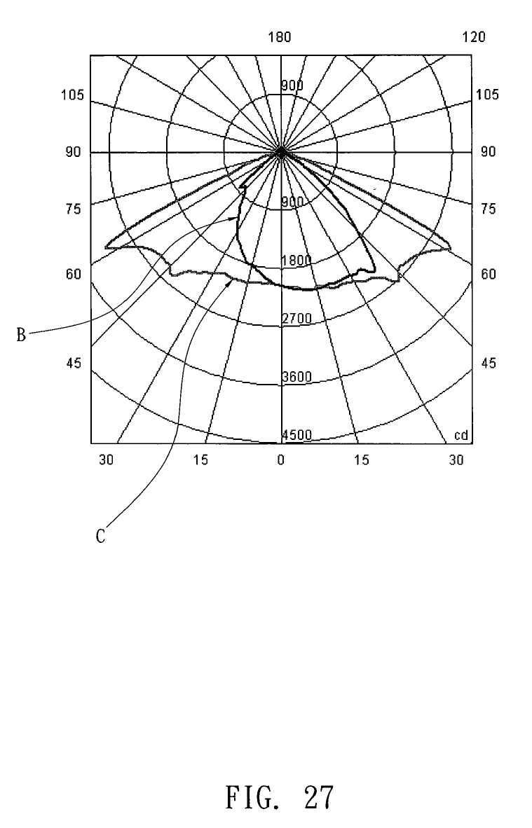

Refer to FIG. 1 & FIG. 2, an optical member 1 of the present invention is used in combination with a solid state lighting element 2 so as to form a lighting device 3, as shown in FIG. 3. The optical member 1 is an optical main body with an emergent surface (a front-side optical surface) 10 and an incident surface (a side optical surface of the light sources) 20. The emergent surface 10 is a spherical surface or an aspherical surface which is designed according to the spherical optical equation or the aspherical optical equation as to generate required light distribution patterns. The emergent surface 10 includes an optical axis 11 and a concave area 12 located in a center of the curved surface thereof. The incident surface 20 is disposed with a V-shaped or V-shaped-like groove 21. The position of the V-shaped or V-shaped-like groove 21 is not restricted in a center of the incident surface 20. The V-shaped groove 21 includes two symmetrical or asymmetrical slants while the V-shape-like groove 21 is formed by a plurality of lines or curves. For example, a curved lead angle is disposed on top of the V-shaped groove or the V-shaped-like groove 21 may be a surface such as a paraboloid, an ellipsoid or an aspherical surface. An optical axis 23 of the incident surface 20 can be overlapped with each other, relatively shifted, relatively slanted or combinations of the above. While the optical member 1 is used in combination with at least one solid state lighting element 2, an asymmetrical and batwing light distribution pattern whose maximum light intensity is not at zero is generated, as shown in FIG. 27, so as to make the emitted area with uniform luminance. Moreover, the surfaces of the V-shaped or V-shaped-like groove 21 of the incident surface 20 can face a spot light source of the solid state lighting element 2 for effective reduction of angle between light beam from the solid state lighting element 2 and a line perpendicular to the surface at the point of incidence (that's the incident surface 20 of the V-shaped groove 21a). Thus the reflection is reduced while the light availability and effectiveness are both increased. Furthermore, the relative position of the optical member 1 and the lighting element 2 is centered relative to each other or shifted relatively.

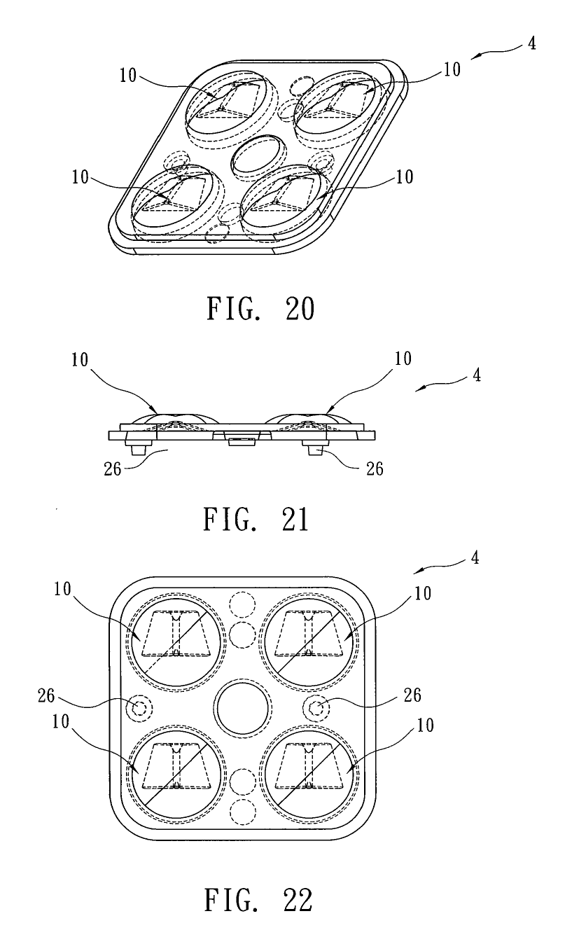

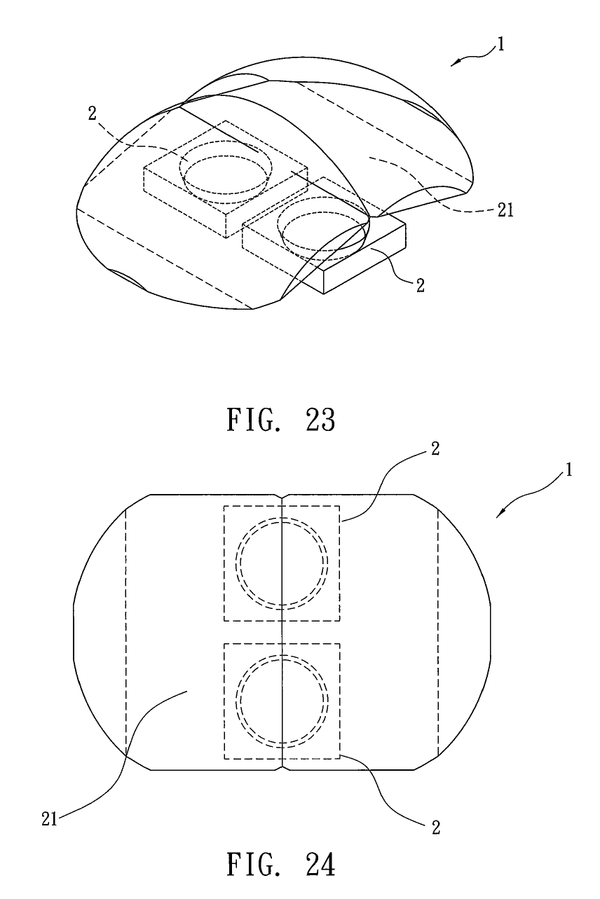

The optical member 1 of the present invention may further include a plurality of emergent surfaces 10 and corresponding incident surfaces 20. As shown in FIG. 20, FIG. 21 & FIG. 22, four emergent surfaces 10 and corresponding incident surfaces 20 arranged in an array or in a staggered way are integrated to form a complex multi-lens optical element 4. The complex multi-lens optical element 4 is used in combination with four solid state lighting elements 2 to form a lighting device so as to simplify production and assembling procedures and reduce manufacturing cost.

### The First Embodiment

Refer from FIG. 1 to FIG. 3, the incident surface 20 of an optical member 1a in this embodiment is disposed with a V-shaped groove 21a and the position of the V-shaped groove 21a is not limited to a center of the incident surface 20. Now the V-shaped groove 21 of this embodiment is arranged on a lower part of the incident surface 20 longitudinally, as shown in FIG. 2. The V-shaped groove 21a is formed by two symmetrical slant surfaces 22. Moreover, the optical axis 23 of the incident surface 20 is overlapped with the optical axis 11 of the emergent surface 10, as shown in FIG. 3. There is no relative displacement between the optical member 1a and the solid state lighting element 2.

Yet in another cross sectional view (turn the FIG. 3 90 degrees, not shown), the optical axes of the optical member 1a and the solid state lighting element 2 may have relative displacement. Refer to FIG. 2, the solid state lighting element 2 is disposed on bottom area of the V-shaped groove 21a, not limited to the central area of the V-shaped groove 21a (21). That means the position is not limited to a middle part of the longitudinal length of the V-shaped groove 21a (21). Thus the V-shaped groove 21 is not restricted to be disposed in the center of the incident surface while the solid state lighting element 2 is not necessarily located on the central area of the V-shaped groove 21. The above designs away from the center may be modified according to users' needs.

As shown in FIG. 3, when the optical member 1 is used in combination with at least one solid state lighting element 2, light beam emitted from the solid state lighting element 2 passes through the two slant surfaces 22 of the V-shaped groove 21a on the incident surface 20 and enters into the optical member 1 so that incident light of the two slant surfaces 22 is refracted in opposite angles, through the spherical surface of the aspherical surface of the emergent surface 10 to be refracted again, and then projected outward. Thus an asymmetric batwing distribution pattern is generated, as a pattern C shown in FIG. 27. The illuminance and luminance on the area to be emitted are uniformed effectively. Moreover, the two slant surfaces 22 of the V-shaped groove 21a faces the spot light of the solid state lighting element 2 at an inclination angle so that the incident angle between light beam from the solid state lighting element 2 and a line perpendicular to the surface at the point of incidence (that's the incident surface 20 of the V-shaped groove 21a) is reduced and the reflection of the light is also reduced. Accordingly, the availability and effectiveness of light are further improved.

### The Second Embodiment

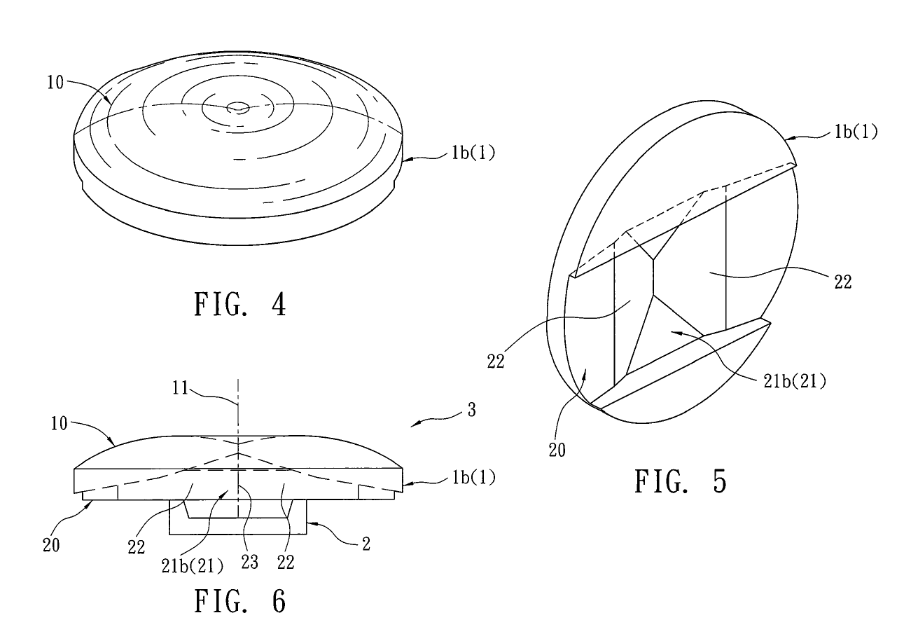

Refer from FIG. 4 to FIG. 6, an incident surface 20 of an optical member 1b in this embodiment is disposed with a V-shaped like groove 21b and the position of the V-shaped like groove 21a is not limited to a center of the incident surface 20. Now the V-shaped like groove 21b of this embodiment is arranged on a lower part of the incident surface 20 longitudinally, as shown in FIG. 5. The V-shaped like groove 21b is formed by a plurality of lines or curves. And the optical axis 23 of the incident surface 20 is overlapped with the optical axis 11 of the emergent surface 10, as shown in FIG. 6. Moreover, there is a relative displacement between the optical member 1b and the solid state lighting element 2. That means the solid state lighting element 2 is not restricted to be disposed on a center of the V-shaped like groove 21b (21). This off-center design is similar to the above embodiment and enables light is directed from the road side to the road forward and the light distribution is as light pattern B in FIG. 27.

The function of the optical member 1b in this embodiment is the same with that of the above embodiment and is used to generate an asymmetrical batwing light pattern, as the light pattern C in FIG. 27. Thus the illuminance and luminance of the area being emitted are effectively uniformed. Furthermore, the reflection is reduced accordingly so that the availability and effectiveness of light are improved.

### The Third Embodiment

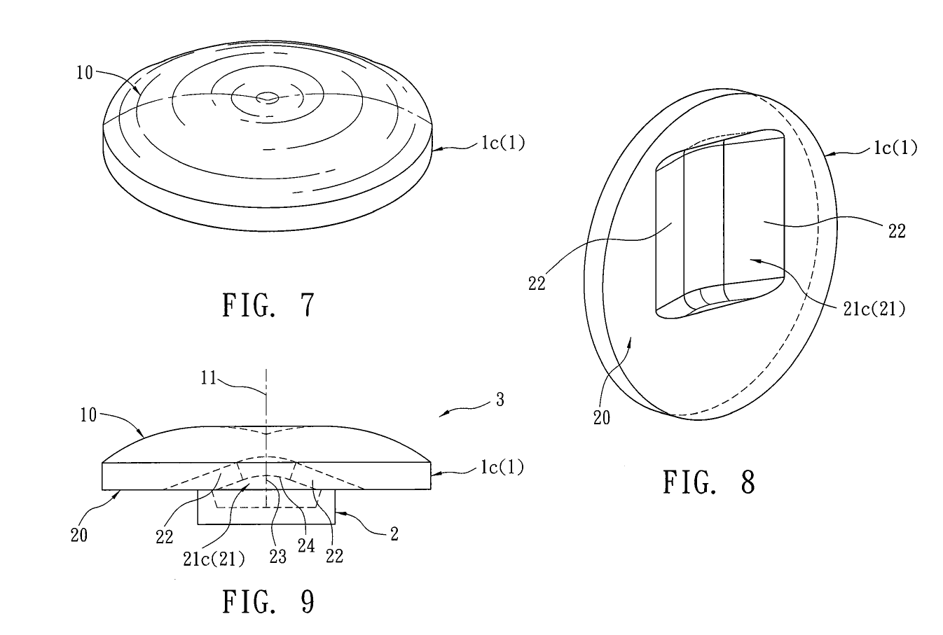

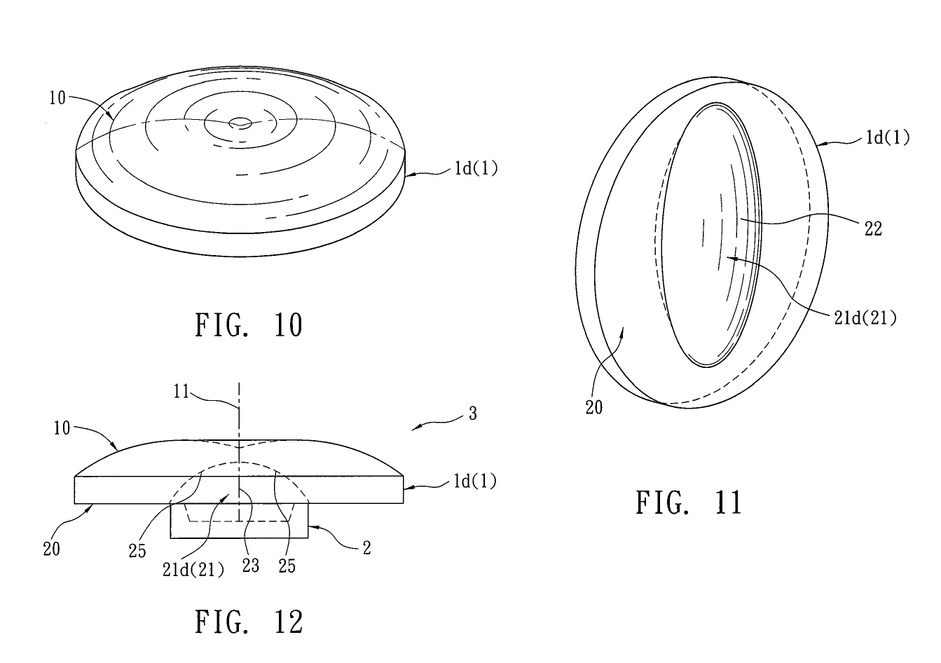

Refer from FIG. 7 to FIG. 9, an incident surface 20 of an optical member 1c in this embodiment is disposed with a V-shaped like groove 21c and the position of the V-shaped like groove 21c is not limited to a center of the incident surface 20. The V-shaped like groove 21c of this embodiment is arranged on an upper part of the incident surface 20 vertically, as shown in FIG. 8. The V-shaped like groove 21c is formed by two symmetrical slant surfaces 22 and a curved lead angle 24 between top and sides of the V-shaped like groove. And the optical axis 23 of the incident surface 20 is overlapped with the optical axis 11 of the emergent surface 10, as shown in FIG. 9. Moreover, the axis of the optical member 1c and the optical axis of the solid state lighting element 2 may be shifted relatively to each other. That represents the position of the solid state lighting element 2 is not limited to the central area of the V-shaped like groove 21c (21). Such off-center design is similar to the first embodiment so that light from road lamps is directed from the road side to the road forward, as the light pattern B in FIG. 27.

The function of the optical member 1c in this embodiment is the same with that of the first embodiment and is used to generate an asymmetrical batwing light pattern, as the light pattern C in FIG. 27. Thus the illuminance and luminance of the area being emitted are effectively uniformed. Moreover, the reflection is reduced. Accordingly, the availability and effectiveness of light are improved.

### The Fourth Embodiment

Refer from FIG. 10 to FIG. 12, an incident surface 20 of an optical member 1d in this embodiment is disposed with a V-shaped like groove 21d and the position of the V-shaped like groove 21c is not limited to a center of the incident surface 20. The V-shaped like groove 21d in this embodiment is arranged on a lower part of the incident surface 20 vertically, as shown in FIG. 11. The V-shaped like groove 21d is formed by a surface such as a paraboloid, an ellipsoid or an aspherical surface. And the optical axis 23 of the incident surface 20 is overlapped with the optical axis 11 of the emergent surface 10, as shown in FIG. 12. Moreover, there is a displacement between the optical axis of the optical member 1b and that of the solid state lighting element 2. That means the solid state lighting element 2 is not necessary to be disposed on a center of the V-shaped like groove 21d (21). This off-center design is similar to the above embodiment and enables light is directed from the road side to the road forward and the light distribution is as light pattern B in FIG. 27.

The function of the optical member 1d in this embodiment is the same with that of the first embodiment and is used to generate an asymmetrical batwing light pattern, as the light pattern C in FIG. 27. Thus the illuminance and luminance of the area being emitted are effectively uniformed. Accordingly, the reflection is reduced so that the availability and effectiveness of light are improved.

### The Fifth Embodiment

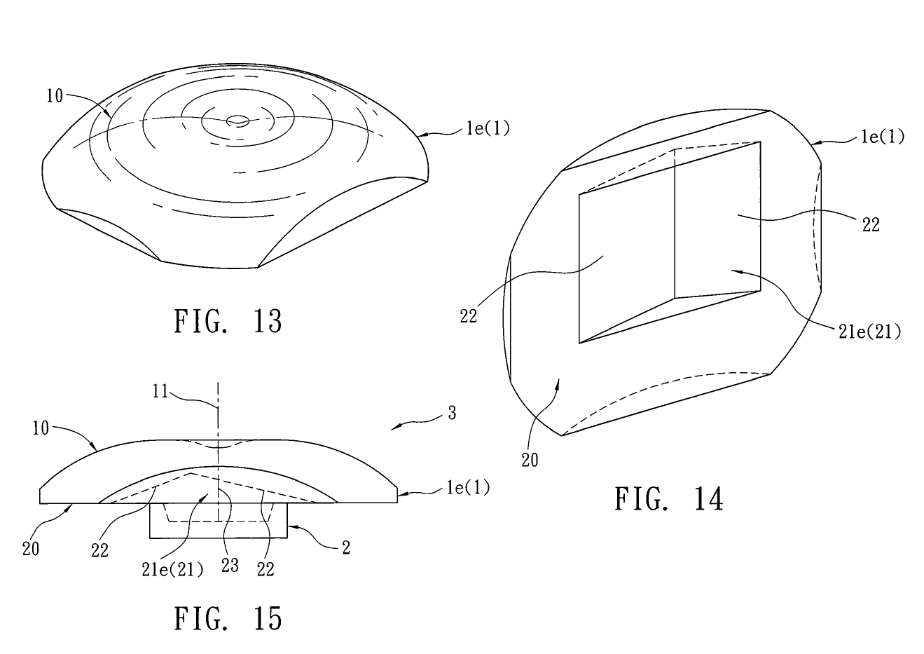

Refer from FIG. 13 to FIG. 15, an incident surface 20 of an optical member 1e in this embodiment is disposed with a V-shaped groove 21e and the position of the V-shaped groove 21e is not limited to a center of the incident surface 20. The V-shaped groove 21e in this embodiment is arranged on an upper part of the incident surface 20 vertically, as shown in FIG. 14. The V-shaped groove 21e is formed by two slant surfaces 22 while the optical axis 23 of the incident surface 20 and the optical axis 11 of the emergent surface 10 are shifted to each other, as shown in FIG. 15. That means the slopes of the two slant surfaces 22 of the V-shaped groove 21e are different and asymmetrical. Moreover, there is a relative displacement between the optical axis of the optical member 1b and that of the solid state lighting element 2. Furthermore, in another cross sectional view (turn the FIG. 15 90 degrees, not shown), the axis of the optical member 1e and the axis of the solid state lighting element 2 also have a relative displacement therebetween. That means the solid state lighting element 2 is not necessarily disposed on the center of the V-shaped groove 21e (21).

The function of the optical member 1e in this embodiment is the same with that of the first embodiment and is used to generate an asymmetrical batwing light pattern, as the light pattern C in FIG. 27. Thus the illuminance and luminance of the area being emitted are effectively uniformed. Accordingly, the reflection is reduced. Thus the availability and effectiveness of light are improved.

### The Sixth Embodiment

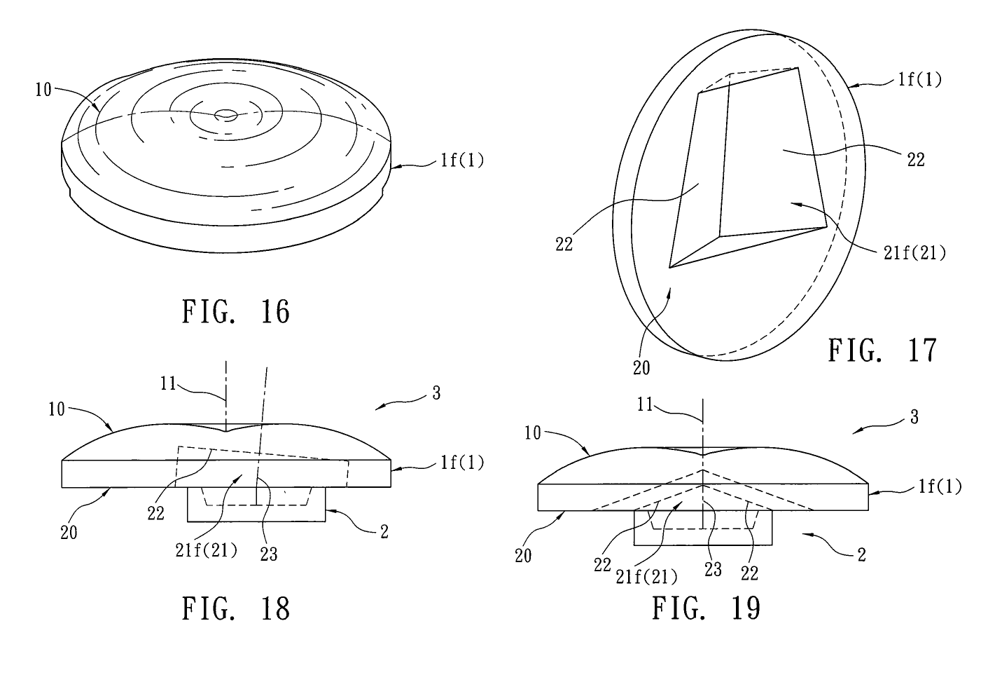

Refer from FIG. 16 to FIG. 19, an incident surface 20 of an optical member 1f in this embodiment is disposed with a V-shaped groove 21f and the position of the V-shaped groove 21e is not limited to a center of the incident surface 20. The V-shaped groove 21f in this embodiment is arranged on an upper part of the incident surface 20 vertically, as shown in FIG. 17. The V-shaped groove 21f is composed of two slant surfaces 22 while the optical axis 23 of the incident surface 20 and the optical axis 11 of the emergent surface 10 are inclined to each other, as shown in FIG. 18. Moreover, there is a relative displacement between the optical axes of the optical member 1f and the solid state lighting element 2. That means the solid state lighting element 2 is not limited to be disposed on the center of the V-shaped groove 21f (21). The off-center design is similar to that of the first embodiment. Thus light is directed from the road side to the road forward, as the light pattern B shown in FIG. 27. The light pattern B and the light pattern C shown in FIG. 27 are obtained by measurement of the optical member 1f of the sixth embodiment.

The function of the optical member 1f in this embodiment is the same with that of the first embodiment and is used to generate an asymmetrical batwing light pattern, as the light pattern C in FIG. 27. Thus the illuminance and luminance of the area being emitted are effectively uniformed. Accordingly, the reflection is reduced. Thus the availability and effectiveness of light are improved.

### The Seventh Embodiment

While being manufactured, there is not only one light emergent surface 10 and one corresponding incident surface 20 of the optical member 1 according to the present invention. The optical member 1 can include a plurality of light emergent surfaces 10 as well as the incident surfaces 20. As shown from FIG. 20 to FIG. 22, the embodiment consists of light emergent surfaces 10 and incident surfaces 20, corresponding to each other and arranged in an array or in an alternating way to form a composite optical member such as a multilens unit 4. The multilens unit 4 is used together with a solid state lighting element 2 one-to-one correspondingly. By such design, the light emitting area of the multilens unit 4 is enlarged. Compared with the optical member in other embodiments with only one light emergent surface 10 and one corresponding incident surface 20, the light emitting area of the multilens unit 4 is larger. Moreover, this design also favors manufacturing of the optical members and assembling of the lighting devices. For examples, in order to form a lighting device having eight vertical optical surfaces and four transverse optical surfaces, use four multilens unit 4 in vertical direction and two multilens unit 4 in horizontal direction. Therefore, the manufacturing as well as assembling is simplified and the manufacturing cost is reduced.

In the above embodiments, the optical axis 23 of the incident surface 20 can be overlapped with the optical axis 11 of the emergent surface 10, as shown from embodiment 1 to embodiment 4, shifted to each other in the fifth embodiment, slanted to each other in the sixth embodiment, or combinations of them (the first embodiment, the fifth embodiment and the sixth embodiment). According to users' requirements, proper optical members are selected. Thus the selectivity of the optical member is improved and the availability of the lighting device is further improved.

### The Eighth Embodiment

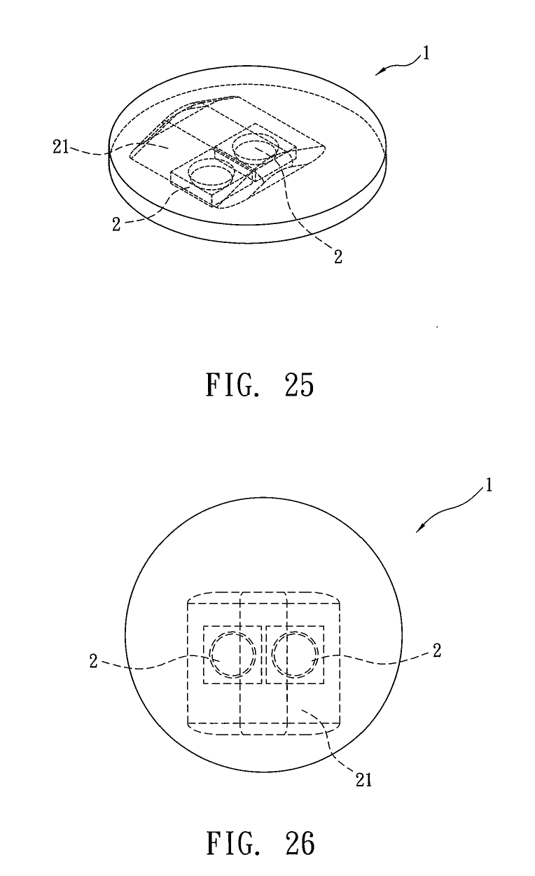

The optical member 1 having an emergent surface 10 and a corresponding incident surface 20 is used in combination with a solid state lighting element 2 one to one correspondingly, as shown from FIG. 1. to FIG. 22. Each optical member 1 having an emergent surface 10 and a corresponding incident surface 20 is used in combination with two solid state lighting elements 2 so as to increase light intensity, as shown in FIG. 23 & FIG. 24, FIG. 25 & FIG. 26. The optical member 1 is an integrated part, or a compound part. The incident surface 20 is disposed with a V-shaped groove, or a V-shaped like groove 21. The two solid state lighting elements 2 can be arranged in parallel vertically, on the incident surface 20. And the total length of the two solid state lighting elements 2 is parallel to one side of the V-shaped groove 21, as shown in FIG. 23 & FIG. 24. Or they may be disposed in parallel horizontally. That means the total length of the two solid state lighting elements 2 is perpendicular to a top side of the V-shaped groove 21, as shown in FIG. 25 & FIG. 26.

There is no limit on the shape of the optical member 1 of the present invention. It can be round, as shown from the first embodiment to the sixth embodiment, a rectangular optical member in the seventh embodiment. Moreover, while assembling a lighting device by a plurality of optical members 1, there is no restriction on assembling way, size, number and arrangement of the optical member 1. These can be modified according to users' requirements. For example, the bottom of the optical member 1 or the multilens unit 4 is disposed with a location pin so that the optical member 1 or the multilens unit 4 can be assembled and located on a circuit board (not shown in figure) easily to work with the solid state lighting element 2 on the circuit board. Or the optical member 1 can be designed into various types so as to be applied to various fields such as street lights, table lamps, car lamps or other products.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An optical member of lighting device used in combination with at least one solid state lighting element comprising at least one emergent surface and at least one incident surface, wherein:
the emergent surface is an optical surface in front of a light source, and is a spherical surface/or aspherical surface;
the incident surface is an optical surface on one side of the light source, facing the solid state lighting element and disposed with a V-shaped groove or V-shaped like groove;
the surfaces on two sides of the groove respectively face the solid state lighting element for improving availability of light;
when the optical member is used in combination with at least one solid state lighting element, light emitted from the solid state lighting element emits into the optical member through surfaces of the groove and projects outward through the emergent surface so as to generate an asymmetrical batwing light distribution pattern whose maximum light intensity is not at zero.

2. The device as claimed in claim 1, wherein the groove of the incident surface includes two slants.

3. The device as claimed in claim 2, wherein the two slants are symmetrical or asymmetrical.

4. The device as claimed in claim 1, wherein a curved lead angle is disposed on top of the V-shaped groove of the incident surface.

5. The device as claimed in claim 1, wherein the groove includes a plurality of lines or curves.

6. The device as claimed in claim 1, wherein the groove is formed by a paraboloid, an ellipsoid or an aspherical surface.

7. The device as claimed in claim 1, wherein an optical axis of the incident surface and an optical axis of the emergent surface are overlapped, shifted relatively to each other, slanted to each other or combinations of them.

8. The device as claimed in claim 1, wherein the optical member includes a plurality of emergent surfaces and corresponding incident surfaces that are arranged in an array or in an alternating way to form a composite optical member.

9. The device as claimed in claim 1, wherein the emergent surface and the incident surface of the optical member are used together with two solid state lighting element.

10. The device as claimed in claim 1, wherein a concave is disposed on center of a surface of the emergent surface of the optical member.
